(19) United States
(12) Patent Application Publication
(10) Pub. No.: US 2011/0194026 A1
(43) Pub. Date: Aug. 11, 2011

(54) METHOD AND SYSTEM FOR VIDEO COPYRIGHT PROTECTION

(75) Inventor: Jean-Marc Reme, Montigny-Le-Bretonneux (FR)

(73) Assignee: KONINKLIJKE PHILIPS ELECTRONICS, N.V., EINDHOVEN (NL)

(21) Appl. No.: 12/063,040

(22) PCT Filed: Aug. 8, 2006
(86) PCT No.: PCT/IB06/52711

§ 371 Date: Feb. 6, 2008

(30) Foreign Application Priority Data
Aug. 8, 2005 (EP) 05300658.1

(51) Int. Cl. H04N 7/03; H04N 7/24; H04N 7/64

(52) U.S. Cl. 348/466; 348/E07.023; 375/E07.021; 375/E07.279

(57) ABSTRACT

The present invention provides an improved method and system for copyright protection in video applications. In particular, the invention is concerned with preventing tampering of or destroying digital watermarking information contained in video images transmitted over error prone networks such as mobile transmission networks. To this end, a robust digital watermark method and system is proposed which protects watermarking by processing an original watermarked video stream (32) having an initial watermarking information and generating (34) at least two separate video streams, where the first stream includes video content information and the second stream includes watermarking information. Next, the two separate video streams using different protocols are transmitted (36), the first stream using a transport protocol for video streaming, and the second stream using a transport protocol having error correction techniques, and then, the two separate video streams are recomposed (38) to generate (39) a final watermarked video stream having the initial watermarking information present in the original video stream.

### FIELD OF THE INVENTION

The present invention relates to digital watermarks, and in particular, the invention relates to a method and system for providing video copyright protection during transmission over error prone networks.

### BACKGROUND OF THE INVENTION

In general terms, in digital watermarking, a pattern of bits are inserted into a digital image, audio or video file that identifies the file's copyright information (author, rights, etc.). The purpose of digital watermarks is to provide copyright protection for intellectual property that comes in digital format. Watermarking is also called data embedding and information hiding. The main application of digital watermarking is in copyright protection. The owner of the image/video adds a watermark to his material before it is distributed. In this way, it is possible to track illegal copies of the copyrighted material. Other possible applications are broadcast monitoring of video sequences (digital TV), DVD protection and access control, database retrieval, and robust identification of digital content

Also, watermarks can be classified as fragile or robust. The fragile watermark is used for detecting even the smallest alteration of an image, while the robust one is specially designed to withstand a wide range of “attacks”, which basically tries to remove the watermark, but without destroying the quality or performance of the image/video. Typically, a watermark can be added to the uncompressed data (raw data), such as a standard uncompressed video sequence as described by ITU-R 601, or it can be added to a compressed bit-stream (MPEG2).

A common and simple way to watermark video is to change directly the values of the pixels, in a spatial domain. A more advanced way is, for example, to insert the watermark in the frequency domain, using one of the well known transforms: FFT (Fast Fourier Transform), DCT (Discrete Cosine Transform) or DWT (Discrete Wavelet Transform). Other techniques are possible as well, like using fractals, for example.

For example, in watermark embedding, the original video can be watermarked with a binary sequence of 64 data-bits, using a secret key, resulting the watermarked video.

Then, once the watermarked video is in the distribution channel, here one may try to attack the watermark in order to destroy it. For example, a pirate who wants to breach the intellectual property rights of the real owner or author, has all the interest to “remove” the watermark. In this case the attacks are considered intentional. It is important, however, that even intentional attacks must not alter the video sequence detrimentally, because the attacker still has the interest to use it, and a bad quality video sequence would be worthless. Some examples of intentional attacks include geometric attacks, frame dropping, collusion, and the like. A different class of attacks are those qualified as unintentional, for example, those caused by typical processing in the video chain and during transmission of the video signal, particularly in error prone networks. Finally, during the watermarking retrieval, which is one of the most difficult parts of the system, one must recover the original watermark intact and uncorrupted.

Many conventional watermarking systems and techniques for distributing copyrighted material have been proposed. For example, UK Patent Application GB 2 390 248 discloses a data processing apparatus and method which aim at processing an original material item to form a reduced-bandwidth-version of the material marked with a code word from a predetermined set of code words. In particular, the data processing apparatus is arranged to form an impaired version of the material for distribution, with the impaired version is formed by generating a reduced-bandwidth version of the material and subtracting the reduced-bandwidth-version from a copy of the original material. Thus, in order to obtain the original material, the recipient must combine the marked-reduced-bandwidth-version with the impaired version of the material. Other proposals such as U.S. Pat. No. 6,233,356 B1 to Haskell et al. discloses a video coding system where an image data is organized into video objects and coded according to a scalable coding scheme, which provides spatial and/or temporal scalability.

However, the conventional techniques described above are not often satisfactory. Very often, before being decoded by a receiver terminal, the watermark video is transmitted over error prone networks, particularly mobile networks, which can introduce a lot of errors during video signal transmissions. To recover the watermark frames without distortion, for example, four coefficients of each block of each I frame of the video must be transmitted correctly over the error prone networks. Otherwise, after the transmission, the watermark retrieval process might not be able to properly recover the copyright, which leads to loss of copyright.

Therefore, in view of these problems, there is a continuing need for developing a new and improved method and device that efficiently protects and prevents digital watermarks from damaging attacks and deals with adequate retrieval of digital watermarks over transmission networks, in particular over error prone networks, while providing an efficient and robust technique for video copyright protection.

### SUMMARY OF THE INVENTION

Accordingly, it is an object of the invention to provide an improved method and system to process video information over an error prone network. In particular, the invention provides processing an original watermarked video stream having an initial watermarking information to generate at least two separate video streams, where a first stream includes video content information and a second stream includes watermarking information, transmitting the two video streams using different respective protocols, where the first video stream is transmitted using a transport protocol for video streaming and the second is transmitted using a transport protocol having error correction techniques, and combining the two video streams to generate a transmitted watermarked video stream having the initial watermarking information present in the original watermarked video stream.

The invention also relates to a method of generating a watermarked video signal for transmission over an error prone network by converting an original watermarked video stream into a first and a second video stream, transmitting the first video stream over the error prone network using a transport protocol for video streaming, and transmitting the second video stream over the network using a transport protocol having error correction techniques, where the first stream includes video content information and the second stream includes watermarking information.

The invention further relates to a method of receiving a video signal transmitted over the error prone network by receiving a first video stream using a transport protocol for video streaming, receiving a second video stream using a transport protocol having error correction techniques, and combining the first and second received video streams to generate a watermarked video stream.

One or more of the following features may also be included.

In one aspect, the two separate video streams include real time transport protocol video streams. The first video stream includes a main real time transport protocol video stream that is missing video information capable of displaying video images having sufficient image quality to be displayed. The second video stream includes a watermarked real time transport protocol video stream having the initial watermarking information provided in the original watermarked video stream.

Other features of the methods are further recited in the dependent claims.

Additionally, the invention also relates to a video transmission system having conversion means for converting an original watermarked video stream into at least a first and a second video stream, transmitting means for transmitting the first video stream over the error prone network using a transport protocol for video streaming, and transmitting means for transmitting the second video stream over the network using a transport protocol having error correction techniques, where the first stream includes video content information and the second stream includes watermarking information.

Moreover, the invention is further directed to a video reception system including receiving means for receiving a first video stream over an error prone network using a transport protocol for video streaming, receiving means for receiving a second video stream over the error prone network using a transport protocol having error correction techniques, and means for combining the first and the second received video streams to generate a watermarked video stream.

One or more of the following features may also be included.

In one aspect, the transport protocol having error correction techniques for the transmission of the second video stream includes selective retransmission or forward error correction techniques to prevent loss of data.

In another aspect, the two separate video streams are configured to transmit using separate, respective Synchronization Source Identifier (SSRC) values in their respective protocol headers. In yet another aspect, the means for combining the first and the second received video streams is configured to combine the at least two separate video streams by synchronizing the two separate video streams using their respective Timestamp values in the transport protocol header.

Other features of the transmission and reception systems are further recited in the dependent claims.

Still further objects and advantages of the present invention will become apparent to one of ordinary skill in the art upon reading and understanding the following drawings and detailed description of the preferred embodiments. As it will be appreciated by one of ordinary skill in the art, the present invention may take various forms and may comprise various components and steps and arrangements thereof.

Accordingly, these and other aspects of the invention will become apparent from and elucidated with reference to the embodiments described in the following description, drawings and from the claims, and the drawings are for purposes of illustrating a preferred embodiment(s) of the present invention and are not to be construed as limiting the present invention.

### BRIEF DESCRIPTION OF THE DRAWINGS

FIG. 1 is a schematic diagram of an example of system according to the present invention;

FIG. 2 is a flowchart illustrating the steps performed when carrying out the method used in the system of FIG. 1;

FIGS. 3A-3C are schematic diagrams illustrating a method of generating watermark real time transport protocol (RTP) streams according to one preferred embodiment of the present invention;

FIG. 4 is a schematic diagram of two video streams generated by the transmission terminal according to one preferred embodiment of the present invention; and

FIG. 5 is a flowchart illustrating a method of reconstituting a MPEG stream with the original watermark information, according to one preferred embodiment of the present invention.

### DESCRIPTION OF THE PREFERRED EMBODIMENTS

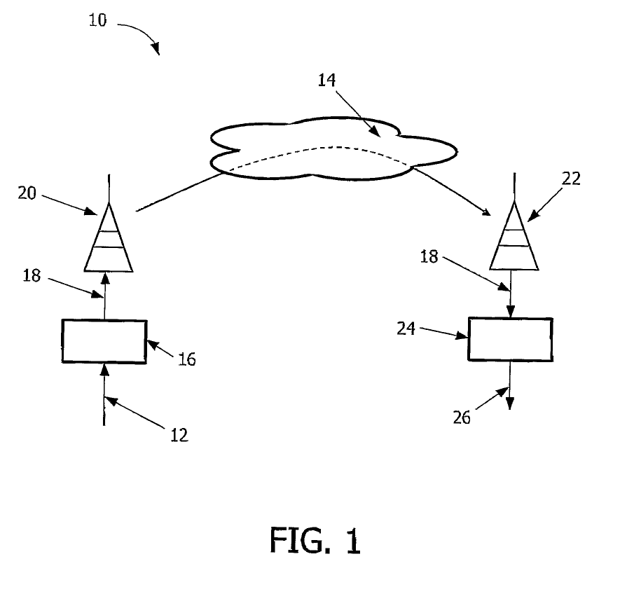

Referring to FIG. 1, a system 10 allows the transmission of a watermarked video stream 12 over an error prone network 14. The system 10 includes a transmission terminal 16, which processes the watermarked video stream 12 using a process that converts the watermarked video stream 12 into a watermark protected signal 18 formed by two RTP (Real Time Transport Protocol) streams for which watermark information is protected against the degradations introduced by the error prone network 14. The watermark protected signal 18 is sent to the error prone network 14, via a transmitter 20, and received by a receiver 22.

Then, the watermark protected signal 18 is processed by a receiver terminal 24 that processes the watermark protected signal 18 using a process that can reconstitute a watermarked video stream 26 with the original watermark information. The method of converting the original watermarked video stream 12 into a watermark protected signal 18 and the method of converting the watermark protected signal 18 back to a watermarked video stream 26 with the original watermark information ensure that even if the error prone network 14 is degrading the video signal, the degraded video stream generated by the receiver terminal 24 is guaranteed to have the original watermark information.

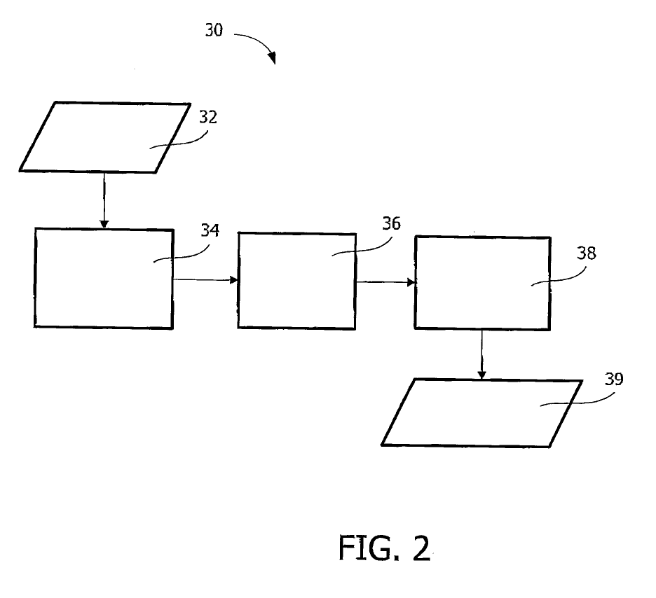

Referring now to FIG. 2, in accordance with the above described system 10, a method 30 illustrates the method of converting the original watermarked video stream into a watermark protected signal and the method of converting the watermark protected signal back to a watermarked video stream with the original watermark information. First, in a step 32, the watermarked video stream is presented to the transmission terminal. Then, next, the transmission terminal converts the watermarked video stream into two RTP streams in a step 34, for example. A first RTP stream includes the main stream, which carries the video stream, and a second RTP stream contains the watermarking information. Both RTP streams are transmitted over an error prone network such as mobile transmission network, in a step 36. The watermarking stream is transmitted using a more robust, protected protocol against errors and disturbances than the main stream. In fact, the watermarking RTP stream is protected against error transmission using specific transmission protocols which are different from the protocol used for the main RTP stream. The protocol used for transmitting the watermarking RTP stream has selective retransmission or forward error correction techniques, and can not be ideally used to transmit the main RTP stream due to overriding performance issues. Thus, the main RTP stream is sent using a protocol that is adapted for video streaming but which cannot provide robust error transmission protection. Accordingly, the error prone network may degrade the quality of the transmission of the main RTP stream, while the watermarking stream is transmitted with no copyright or watermarking information loss.

Next, the main stream contains video information but without enough information to be displayed with an acceptable quality on the receiver terminal. Therefore, it requires information from the watermarking stream. In a step 38, the receiver terminal recomposes and processes the watermarked video using both streams, which combines the two streams to reconstitute and generate a video stream with the original watermark information, in a step 39.

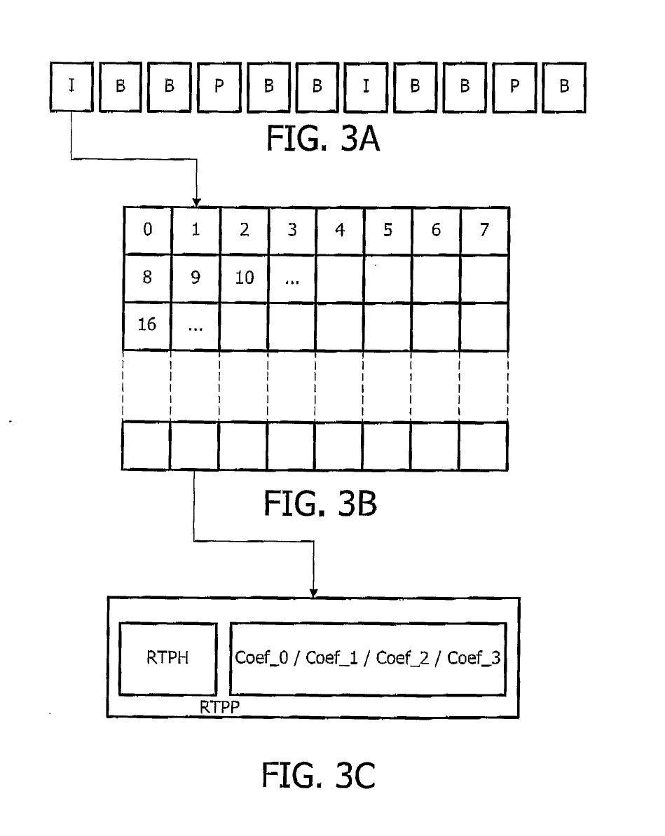

Referring to FIG. 3, the method of generating the watermark RTP streams are diagrammatically illustrated. As shown in FIG. 3A, the watermark RTP stream is generated from a traditional MPEG video stream. A MPEG “film” is a sequence of three possible kinds of frames: I-Frames, P-Frames and B-Frames. The I-frames are said to be intra-coded, i.e. they can be reconstructed without any reference to other frames. The P-frames are forward predicted from the last I-frame or P-frame, in other words, it is impossible to reconstruct them without having the data of another frame (I or P-Frames). The B-frames are forward predicted and backward predicted from the last/next I-frame or P-frame, in other words, two other frames are necessary to reconstruct them. P-frames and B-frames are referred to as being inter-coded frames. In FIG. 3A, the frame sequence of an exemplary MPEG film is shown as “I B B P B B I B B P B.”

Among some conventional robust digital watermark techniques, one method is the so-called “high-capacity block based video watermarking scheme,” as described in S. Thiemert, T. Vogel, J. Dittmann, M. Steinebach's paper entitled “A High-Capacity Block Based Video Watermark”, Proceedings of the 30^{th} EUROMICRO Conference (EUROMICRO'04). The main idea in this high-capacity block based video watermarking scheme, for example, is to embed a bit of message by enforcing a relationship into a group of video blocks. This watermarking scheme concerns only I frames of a MPEG stream, and has no impact on B-frames or P-frames. The high-capacity block based video watermarking scheme splits each I-frame of an MPEG stream into rectangular regions called “blocks groups,” as illustrated in FIG. 3B. In this prior art scheme, watermark information is embedded within the image. The watermark information is a mathematical relation between some elements of the block. For instance, four elements (Coefficient_0, Coefficient_1, Coefficient_2 and Coefficient_3) for each block of each I-frame (called Coef_0, Coef_1, Coef_2, Coef_3 in FIG. 3C) are concerned by the mathematical relation. As a result, if the image is degraded during the transmission over an error prone network, unfortunately, the watermark information can be lost.

In contrast, in the present invention, prior to transmission over the error prone network, watermark information is extracted from the video stream encoded using a technique such as the conventional scheme described above. Then, it is proposed to generate, per I-frame, one RTP packet (RTPP) containing all the watermarking information for one frame. This is illustrated in FIG. 3C (RTPH designates the RTP header of the packet).

For example, watermarking is performed using four coefficients per block group. All the blocks of an I-Frame are ordered (block0, block1 . . . ). This order is also known by the receiver and is respected into the RTP packet containing the watermark information. Therefore, the receiver keeps track and “knows” the place of each block in the associated I-Frame. The method also ensures that the content of an I-Frame is transmitted in the main stream without enough information to be displayed with an acceptable quality on the receiver terminal if it is not resynchronized with the watermarking information by the receiving terminal. That is, a decoded first video stream gives a video of very inferior bad quality, which cannot be displayed on its own. A decoded second video stream, thus, is essential to obtain an acceptable good video quality for viewing.

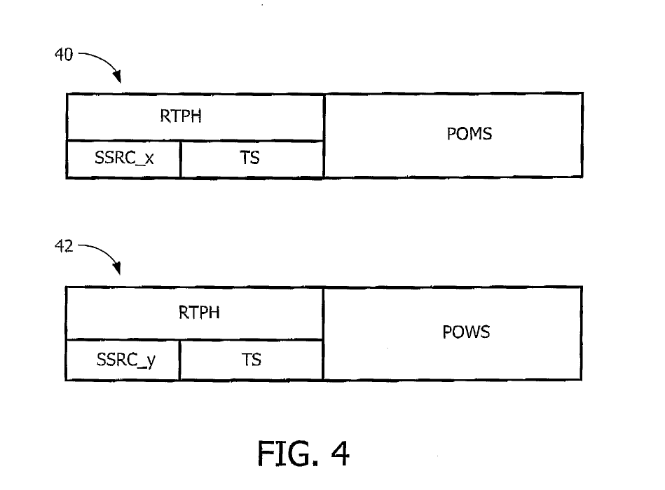

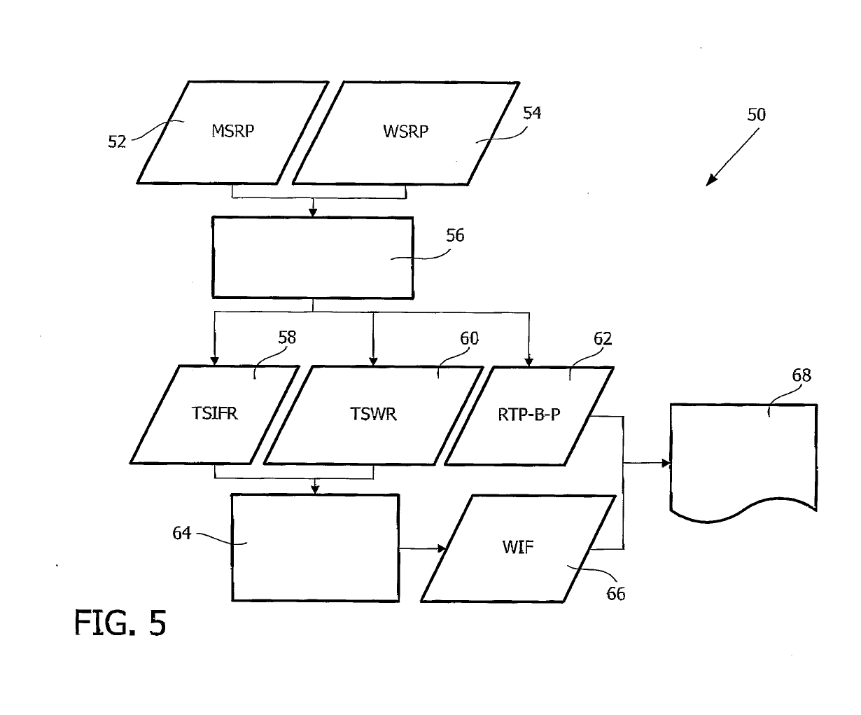

Referring now to FIG. 4, two RTP streams 40 and 42 generated by the transmission terminal are illustrated. To distinguish the main RTP stream (a RTP stream 40) from the watermarking stream (a RPT stream 42), the transmission terminal assigns a specific Synchronization Source Identifier (“SSRC_”) for each type of RTP stream. Each RTP packet (POWS) of the watermarking stream 42 has the same SSRC, which is different from the SSRC of the RTP packets (POMSs) of the main stream 40. In order to resynchronize the packets of the main RTP stream 40 and the watermarking stream 42, a timestamp (TS) information provided in the RTP header protocol is used. This method is further illustrated in the next FIG. 5.

Referring to FIG. 5, a method 50 illustrates a process of reconstituting or recombining a MPEG stream 68 with the original watermark information provided in the MPEG stream processed by the transmission terminal. Using main stream RTP packets (MSRP) 52 and watermarking stream RPT packets 54, the receiver terminal processes the RTP headers by sorting the RTP packets into three distinct groups in a step 56 by analyzing (in RTP packet headers) the SSRC and TS information on the main stream RTP packets 52 and watermarking stream RTP packets 54. That is, using the SSRC information, the receiving terminal is able to distinguish watermarking packets 54 from the main stream packets 52.

As a result, the receiver terminal is then able to extract three families of packets: Time Stamped I-Frames RTP packets 58 (TSIFR), Time Stamped watermarking RTP packets 60 (TSWR), and RTP packets for B-Frames and P-Frames 62 (RTP-B-P). Then, next, in a step 64, using the TS information in the RTP headers and the blocks order, the receiver terminal links the watermarking RTP packets 60 with the I-Frames packets 58 as they were associated by the transmission terminal. Consequently, a complete watermarked I-Frame 66 (WIF) that can be displayed with an acceptable video quality is then reconstituted by the receiver terminal. In fact, by synchronizing all watermarked I-Frames, B-Frames and P-Frames, it is possible to reconstitute a MPEG stream 68, which has the original watermarking information processed by the transmission terminal.

While there has been illustrated and described what are presently considered to be the preferred embodiments of the present invention, it will be understood by those of ordinary skill in the art that various other modifications may be made, and equivalents may be substituted, without departing from the true scope of the present invention.

Additionally, many advanced video copyright protection processes and systems may be made to adapt a particular situation to the teachings of the present invention without departing from the central inventive concept described herein. Furthermore, an embodiment of the present invention may not include all of the features described above. Therefore, it is intended that the present invention not be limited to the particular embodiments disclosed, but that the invention include all embodiments falling within the scope of the appended claims and their equivalents.

1. A method (30) of processing video information over an error prone network (14), wherein the method comprises:
processing (32) an original watermarked video stream having an initial watermarking information to generate (34) at least two separate video streams, wherein a first stream comprises video content information and a second stream comprises watermarking information;
transmitting (36) the at least two separate video streams using different respective protocols, wherein the first video stream is transmitted using a transport protocol for video streaming and the second video stream is transmitted using a transport protocol having error correction techniques; and
combining (38) the at least two separate video streams to generate (39) a transmitted watermarked video stream having the initial watermarking information present in the original watermarked video stream.

2. A method of generating a watermarked video signal for transmission over an error prone network (14), comprising:
converting (34) an original watermarked video stream into at least a first and a second video stream;
transmitting the first video stream over an error prone network (14) using a transport protocol for video streaming; and
transmitting the second video stream over the error prone network (14) using a transport protocol having error correction techniques, wherein the first stream comprises video content information and the second stream comprises watermarking information.

3. A method of receiving a video signal transmitted over an error prone network (14), comprising:
receiving a first video stream over an error prone network (14) using a transport protocol for video streaming;
receiving a second video stream over the error prone network (14) using a transport protocol having error correction techniques; and
combining (38) the first and the second received video streams to generate a watermarked video stream.

4. The method of claim 1, wherein the at least two separate video streams comprise real time transport protocol video streams.

5. The method of claim 1, wherein the first video stream comprises a main real time transport protocol video stream that is missing video information capable of displaying video images having sufficient image quality to be displayed.

6. The method of claim 1, wherein the second video stream comprises a watermarked real time transport protocol video stream having the initial watermarking information provided in the original watermarked video stream.

7. The method of claim 1, wherein the transport protocol having error correction techniques for the transmission of the second video stream comprises selective retransmission or forward error correction techniques to prevent loss of data.

8. The method of claim 1, wherein the at least two separate video streams are transmitted using separate, respective Synchronization Source Identifier (SSRC) values in their respective protocol headers.

9. The method of claim 1, wherein combining the at least two separate video streams comprises synchronizing the at least two separate video streams using their respective Timestamp values in the transport protocol header.

10. A video transmission system (16) comprising:
conversion means for converting an original watermarked video stream into at least a first and a second video stream;
transmitting means for transmitting the first video stream over an error prone network (14) using a transport protocol for video streaming; and
transmitting means for transmitting the second video stream over the error prone network (14) using a transport protocol having error correction techniques, wherein the first stream comprises video content information and the second stream comprises watermarking information.

11. A video reception system (24) comprising:
receiving means for receiving a first video stream over an error prone network (14) using a transport protocol for video streaming;
receiving means for receiving a second video stream over the error prone network (14) using a transport protocol having error correction techniques; and
means for combining the first and the second received video streams to generate a watermarked video stream.

12. The system of claim 10, wherein the at least two separate video streams are real time transport protocol video streams.

13. The system of claim 10, wherein the first video stream is a main real time transport protocol video stream missing video information capable of displaying video images having sufficient image quality to be displayed.

14. The system of claim 10, wherein the second video stream is a watermarked real time transport protocol video stream having the initial watermarking information provided in the original watermarked video stream.

15. The system of claim 10, wherein the transport protocol having error correction techniques for the transmission of the second video stream comprises selective retransmission or forward error correction techniques to prevent loss of data.

16. The system of claim 10, wherein the at least two separate video streams are configured to transmit using separate, respective Synchronization Source Identifier (SSRC) values in their respective protocol headers.

17. The system of claim 11, wherein the means for combining the first and the second received video streams are configured to combine the at least two separate video streams by synchronizing the at least two separate video streams using their respective Timestamp values in the transport protocol header.

18. A computer-readable medium having a sequence of instructions stored thereon which, when executed by a microprocessor of a video processing device, causes the processor to:
convert (34) an original watermarked video stream into at least a first and a second video stream;
transmit the first video stream over an error prone network (14) using a transport protocol for video streaming; and
transmit the second video stream over the error prone network (14) using a transport protocol having error correction techniques, wherein the first stream comprises video content information and the second stream comprises watermarking information.

19. A computer-readable medium having a sequence of instructions stored thereon which, when executed by a microprocessor of a video processing device, causes the processor to:
receive a first video stream over an error prone network (14) using a transport protocol for video streaming;
receive a second video stream over the error prone network (14) using a transport protocol having error correction techniques; and
combine (38) the first and the second received video streams to generate a watermarked video stream.
